(19) United States
(12) Patent Application Publication
(10) Pub. No.: US 2008/0260912 A1
(43) Pub. Date: Oct. 23, 2008

(54) Foam Branding Process and Apparatus Therefor

(76) Inventor: Owen Scott, Ashaway, RI (US)

Correspondence Address: MCCORMICK, PAULDING & HUBER LLP, CITY PLACE II, 185 ASYLUM STREET, HARTFORD, CT, 06103, US

(21) Appl. No.: 10/557,765

(22) PCT Filed: Jun. 6, 2005
(86) PCT No.: PCT/US05/19779

§ 371 Date: Oct. 19, 2007

(51) Int. Cl. A23P 1/00; B29C 44/56

(52) U.S. Cl. 426/87; 99/451

(57) ABSTRACT

The present invention provides a process and apparatus for branding a foam portion formed on the surface of a liquid beverage disposed in a container. The process includes providing a heat source defining an area corresponding to the shape of a desired brand to be formed in the foam and heating the heat source to a temperature of at least about 212 degrees Fahrenheit. The heat source is then engaged with the foam thereby vaporizing the foam in the area of the brand without disturbing the foam adjacent to the brand. The process further includes allowing the vaporized foam to escape to the atmosphere, thus the foam adjacent the brand is not disturbed. The apparatus includes a body, a die coupled to the body and defining a face having a shape corresponding to a desired brand to be formed in the foam. A heating element is coupled to the die.

### CROSS REFERENCE TO RELATED APPLICATION

This application claims priority to U.S. Provisional Patent Applications, Ser. No. 60/577,140 filed Jun. 4, 2004 entitled “Foam Branding Process and Apparatus Therefor” and Ser. No. 60/590,085 filed Jul. 22, 2004 entitled “Die For Branding Foam”. The disclosure of each of the above-identified provisional applications is incorporated in its entirety herein by reference.

### TECHNICAL FIELD

The present invention relates generally to branding the head or foam portion of a beverage disposed in a container. More particularly, the present invention provides a process and apparatus for branding the foam portion of a beverage disposed in a container such that a design or logo is formed in the foam portion.

### BACKGROUND ART

It is known to mark the head of a beverage such as beer by creating in the foam bead formed on the top of a poured glass of beer a design such as a shamrock.

Typically, a mark is formed in the head of a beer by a bartender during the pouring of the beer by moving a glass containing the beer relative to the tap or source of the beer such that a design is formed in the foam head formed on the surface of the beer. However, the quality of the design formed depends almost entirely on the skill of the bartender and therefore, the designs formed on a plurality of individual beers may not be consistent from one beer to the next, especially if more than one bartender is drawing the beer.

Additionally, mechanical devices have been developed for marking the head of a beverage such as that shown in U.S. Published Patent Application No. 2002/0176913 wherein a device is shown that is designed to be placed inside the beverage glass prior to drawing the head of a beverage and then removed from the glass such that the foam resting on the device is also removed, thereby forming an image in the shape of the device. However, the shape of the device can vary depending on the angle the glass is moved away from the device, thus, the consistency of the designs created using this type of device also depend on the skill of a bartender or other person drawing the beverage.

Based on the foregoing, it is the general object of the present invention to provide a process and apparatus for branding the foam head of a beverage disposed in a container that improves upon, or overcomes the problems and drawbacks associated with prior art methods and devices.

### DISCLOSURE OF INVENTION

The present invention provides a process for branding a foam portion formed on the surface of a liquid beverage disposed in a container. The process includes providing a heat source defining an area corresponding to the shape of a desired brand to be formed in the foam and heating the heat source to a temperature of at least about 212 degrees Fahrenheit The heat source is then engaged with the foam thereby vaporizing the foam in the area of the brand without disturbing the foam adjacent to the brand. The process further includes allowing the vaporized foam to escape to the atmosphere, thus the foam adjacent the brand is not disturbed.

The present invention also provides an apparatus for branding a foam portion formed on the surface of a liquid beverage disposed in a container. The apparatus includes a body, a die coupled to the body and defining an extended face having a shape corresponding to a desired brand to be formed in the foam portion. A heating element is coupled to the die for heating the die. The face is engageable with the foam portion of a liquid for branding foam in the shape of the face of the die.

In another aspect, the present invention provides a die for use with an apparatus for branding a foam portion formed on the surface of a liquid beverage disposed in a container. The die including a heat block, a transfer portion coupled to the heat block, and an extended face coupled to the transfer portion, the extended face defining a shape corresponding to the shape of a desired brand. The apparatus having a heating element coupled to the heat block for heating the heat block and thereby the face, the face being engageable with the foam portion of a liquid for branding the foam in the shape of the face of the die.

In general the foam branding process presented uses a sudden application of significant directed heat in the configuration shape and size as the image desired to be created in the dense foam head sitting on top of a liquid as it being held in a container. Typically the beverage is beer, however the invention can be used with other beverages such including coffee latte. The directed heat, normally set at a pre-determined temperature in excess of 212° F. as determined by the density and thickness of the foam and the presence of any organic matter in the foam, is suddenly inserted into the foam for the purpose of breaking the surface tension attracting the molecules of air bubbles and their liquid sheaths that form the foam; thereby vaporizing the liquid sheaths surrounding the molecules of air bubbles, thereby releasing the entrapped air and vapor to the atmosphere, while ‘cooking’ and/or ‘frying’ any organic matter present in the foam; resulting in a specified image impressed/branded to be created in the foam head in the precise configuration, shape and size as the directed/inserted heat. It is critical that the directed heat inserted into the foam is accomplished without the directed/inserted heat touching and/or boiling the liquid beneath the foam. If the heated die boils the liquid below the foam, the outline of the image being created in the foam above the liquid will be distorted and blurred making the image to be distorted or unrecognizable.

The die depth adjusting capability provided by the apparatus controls the depth of the die insertion into the foam and is used to prevent the die from touching and boiling the liquid in the container that the foam is sitting on; additionally the die adjusting capability provides a necessary space between the heat transfer base of the die and the foam, thereby allowing the escaping air and steam vapor to be released into the atmosphere without disturbing the adjacent air bubbles forming the image in the foam.

The apparatus is specifically designed to enhance the commercial application and acceptability of the foam branding invention presented. The apparatus addresses the commercial needs of speed and consistency of application, sanitary requirements, maintenance concerns and user training requirements, etc.

In a preferred embodiment, the apparatus utilizes a 110 volt, 100 watt electric heating assembly for heating the die in excess of 212° F., as determined by the density and thickness of the foam, the presence of any organic matter in the foam. The apparatus minimizes the temperature of heat transfer from the heating element by the use of an insulating cup housing the die heating assembly.

To accomplish the branding of an image of an object in the dense foam head of a liquid the user performs the following sequential activities: (1) adjust the depth of the directed heat of the die to be inserted into the foam head to approximately ⅛″ to ¼,″ as determined by the density and thickness of the foam and the presence of any organic matter in the foam; (2) plug the apparatus into a 120 volt electrical outlet and turn the apparatus to the “on” position to heat the die; (3) place the container, holding the liquid with the foam head sitting on it, in the recessed throat area of the body to correctly position the container prior to engaging the container with the container alignment device; (4) rapidly raise the container by sliding the container up the container alignment device; (5) the rapid upward movement of the container up the alignment device engages the directed/inserted source of the die to its controlled depth by pressing the dense foam head, sitting on top of the liquid held in the container, into the die; without the die touching and boiling the liquid the foam is sitting on; (6) immediately after the foam engages the die to its adjusted depth, the upward movement of the container is immediately reversed to a downward movement so as to rapidly remove the foam head from the heated die.

The result is a clearly defined branding of a specified image in the foam head sitting on top of a liquid held in a container, in the precise configuration, shape and size of the heat source of the die; and which will remain visible for up to several minutes depending on the density, thickness of the foam and the ‘cooking’ and/or ‘frying’ of any organic matter in the foam.

An alternative hand-held apparatus is generally constructed exactly the same as the stand-alone stationary apparatus presented in this invention, except that the base area, and the recessed throat area of the apparatus are not needed in a hand held apparatus, and are therefore eliminated. A hand-held apparatus would be used by an operator holding the heating assembly in his/her hand and moving the apparatus in a downward movement to suddenly insert the die into the dense foam head sitting on top of liquid a stationary container. In the hand held apparatus, the container holding the liquid with the foam on top is held stationary. In the standalone apparatus presented in this invention, the apparatus is stationary.

The commercial acceptability of an apparatus used to create the image of an outline in a foam head sitting on top of a liquid/beverage as it is held in its container, must meet several user standards of practicability, as follows:

1. It cannot change the taste.

2. Additives cannot be used.

3. It must be done sanitarily, i.e., 100% germ free.

4. It must be done quickly, i.e., in a very few seconds.

5. It must be done consistently, i.e., repeatedly one after the other.

6. It must be user friendly, i.e., require minimum user training.

7. It must provide for quick and easy cleaning.

The invention presents an apparatus, a die and a process as the method used to create an image in the dense foam head, sitting on top of a liquid as it is held in its container.

The process disclosed includes the application of directed significant heat source, designed in the specific configuration, shape and size as the object, to be suddenly inserted into the foam head to create a specified image in the foam; and which is accomplished without the directed/inserted heat touching and boiling the liquid the foam is sitting on; and which is done for the sole purpose of breaking the surface tension attracting the molecules of air bubbles and their liquid sheaths that form the foam; thereby releasing the entrapped air and vapor to the atmosphere while ‘cooking’ and/or ‘frying’ any organic matter present in the foam.

The result of which is the creation of an outline of a specified image, letter or object impressed/branded in the foam head sitting on top of the liquid in the container, in the precise shape, size and configuration as the directed/inserted heat source. Most importantly the process described above addresses and meets the stated standards of acceptability.

The apparatus described is designed and used to apply the process of the invention disclosed. The apparatus is designed with several unique features including the following:
(1) a base area designed to perform the critical function of providing stability to the apparatus that ensures its safe use by an operator while in use sitting on a counter top or table;
(2) a throat area that provides the necessary quick and correct positioning of the container prior to the container engaging an alignment device. The primary function of the throat area is to provide a defined space for positioning and aligning the container as a means to consistently and rapidly apply the sudden insertion of the heated die into the foam head.
(3) a top area that houses the heating assembly that provides the directed heat source directly to an attached die; a heat insulating cup used to minimize heat transfer to the top of the body. The die presented in this invention is held in the top area of the apparatus in a specified position in relation to the container with the foam head sitting on top of it, thereby ensuring the consistent application of the directed heat source of the die into the foam head.

Each of the three areas of the die provided unique capabilities needed to brand an image of an object in the foam head sitting on top of a liquid, as follows:
(1) the heat transfer base of the die absorbs the heat radiating from the heating assembly and heating block and evenly distributes the heat to the die face needed. Each of the three areas of the die provide unique capabilities needed to brand a to bring the surface areas of the die face to the specified temperature for extended periods.
(2) a specified depth or height of the extended die face in conjunction with the die the adjusting capability is used to control the depth insertion of the die into the foam head, as adjusted by the die adjusting lever, in order to prevent the directed/inserted heat source of the die from touching and boiling the liquid the foam is sitting on.

The extended depth of the die face is suddenly inserted into the foam to its adjusted depth, a space is provided between the top of the foam and the bottom of the die face heat transfer base; the space allows the escaping air and steam vapor from the broken air bubbles that form the image in the foam to be released to the atmosphere without disturbing the (unbroken) adjacent air bubbles that form the outline of the image in the foam.

It is noted that there is more than one source of directed/inserted heat that can be used to apply the process presented in this invention including a die, a laser, an ultrasound, etc. However the single feature common to any application of the process presented in this invention requires that a controlled directed heat source be suddenly inserted into the foam head sitting on top of a liquid being held in a container without the directed and inserted heat touching and boiling the liquid the foam head is sitting on as it is being held in a container; for the purpose of breaking the cohesive forces of surface tension attracting the molecules of air bubbles and their liquid sheath that form the foam.

The apparatus presented in this invention prevents the source of directed/inserted heat of the die from touching and boiling the liquid the foam is sitting on by controlling the depth of insertion of the directed heat source of the die.

The invention presented uses a uniquely designed and machined aluminum die as its source of directed significant heat that is suddenly inserted into the foam head sitting on top of a liquid being held in a container, by applying the process using the apparatus and the die presented, in a series of sequential actions:
(1) adjust the depth that the die is to be inserted into the foam relative to the density and thickness of the foam;
(2) plug the apparatus into a 120-volt electrical outlet and turn the apparatus to the ‘on’ position to heat the die to a predetermined, preset temperature;
(3) place the container holding the liquid with the foam head sitting on top of it as it is being held in its container, in the recessed throat area of the body to correctly position the container prior to the container engaging the alignment device;
(4) engage the container with the alignment device as the user raises the container of liquid with the foam head sitting on top of it by rapidly sliding the container up the alignment device, held in position in the top area of the apparatus body, to align the container with the foam head with the die;
(5) continue to move the container rapidly up the alignment device until the foam engages the heated die by pressing the foam, sitting on top of the liquid held in a container, into the die face to its controlled depth;
(6) when the foam has been pressed into the die to its controlled depth, the upward movement of the container is immediately reversed to a downward movement to rapidly remove the foam head from the die.

The result is a clearly defined impression and/or branding of the specified image in the foam head, in the precise configuration, shape and size of the die and which will remain visible for up to several minutes depending on the density, thickness of the foam and the ‘cooking’ and/or ‘frying’ of any organic matter present in the foam.

The image created in the foam head is produced consistently, rapidly, sanitarily, safely and requiring minimum user training.

### BRIEF DESCRIPTION OF DRAWINGS

FIG. 1 is a perspective view of one embodiment of the apparatus of the present invention shown with a glass container typically used with the apparatus for holding a beverage such as beer.

FIG. 2 is a cross sectional side view of the apparatus of FIG. 1.

FIG. 3 is an exploded view of a heating assembly of the apparatus of FIG. 1.

FIG. 4 is a schematic wiring diagram of the apparatus of FIG. 1.

FIG. 5 is a cross section view of a die in accordance with the present invention.

### BEST MODE FOR CARRYING OUT THE INVENTION

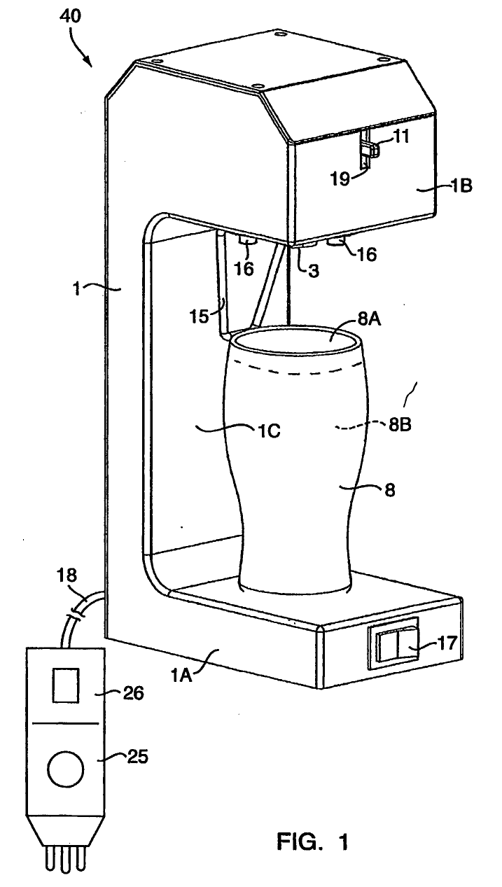

As shown in FIG. 1, the rotated view of the completed apparatus graphically illustrates the apparatus generally designated by the reference numeral 40, including (1) a body 1, (2) a base area 1A; (2) a top area 1B; and (3) a throat area 1C. The throat area 1C separates the base area 1A from the top area 1B of the body 1.

FIG. 1 illustrates that the base area 1A supports the apparatus in a stationary stand alone upright position, while holding the apparatus firmly in place for use on a counter or a table top; thereby ensuring the stability and safety of the apparatus while in use.

FIG. 1 graphically illustrates the placement of a container 8 in the required position prior to the container 8 making contact with an alignment device 15. The alignment device 15 is used to guide a container 8 vertically up the throat area of the body 1 to correctly align container 8 with a die 3 held in position in the top area 1B.

FIG. 1 graphically illustrates the base 1A containing an “on/off” switch with an integral “on/off” indicator light 17.

FIG. 1 graphically illustrates the electrical power supplied by an electrical cord generally designated by the reference numeral 18, which Includes a 3-pronged ground-fault plug 25 and a rheostat 26. The ground fault plug 25 prevents accidental electrical shock. The rheostat 26 controls and adjusts the electric voltage supplied to switch 17.

FIG. 1 graphically illustrates hollow base 1A separated from an open top area 1B by a hollow recessed throat area 1C. The recessed throat area 1C is designed and manufactured to a specified depth and height, as determined by the height and size of the container 8, sufficient to place the container 8, holding the foam head 8 A sitting on top of the liquid 8B, in the correct position; thereby readying the container 8 for making contact with the alignment device 15.

The recessed throat area 1C of the apparatus 40 in the invention presented is critical to the successful commercial operation of the apparatus 40 because the recessed throat area 1C is a specifically designed area that provides the required space necessary in order to rapidly, consistently and correctly place a container 8 in its correct position for movement up an alignment device 15 readying the container 8 prior to the container 8 engaging the die 3.

FIG. 1 also graphically illustrates that an adjusting lever 11 is held in position in an adjusting lever positioning slot 19 in the top area 1B. The adjusting lever 11 is depicted positioned vertically and horizontally in the center of the top area 1B of the body 1 in a adjusting lever slot 19 designed to limit the up and down travel of the adjusting lever 11 to approximately ⅜″ in either an up or down movement, when starting with the adjusting lever 11 set horizontally in the center of the adjusting lever slot 19.

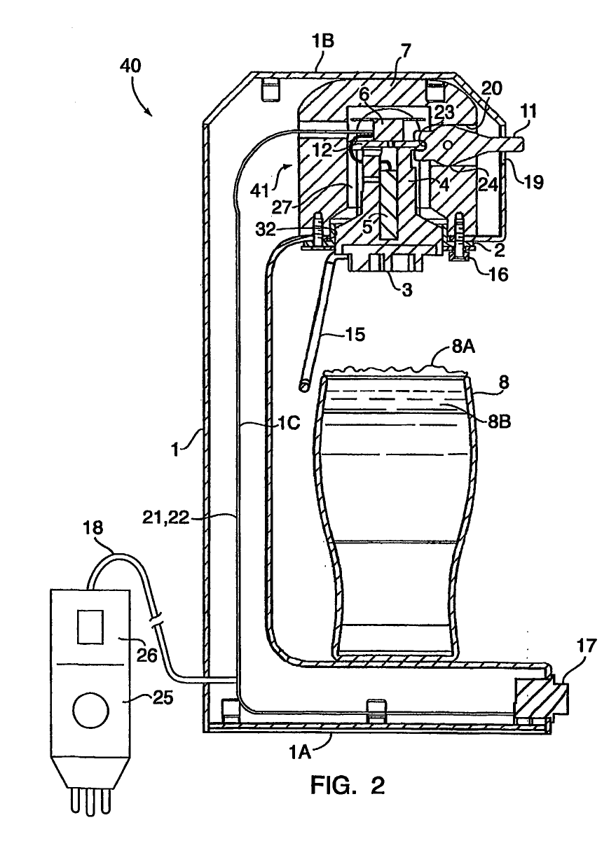

A cross section of the apparatus is shown in FIG. 2, the apparatus is generally designated by the reference number 40 with the base area 1A of the body 1 separated from the top area 1B of the body 1 by a recessed throat area 1C of the body.

FIG. 2 depicts the top area 1B housing a die heating assembly generally designated by the reference number 41 includes several separate but interrelated components, as follows: (1) a thermostat 6; (2) a thermostat mount 12; (3) a heating block 4; (4) a cartridge heater 5; (5) an adjusting lever 11; (6) an adjusting lever positioning and holding channel 20; (7) an adjusting lever fulcrum point 24; (8) a seal 2; (9) an alignment device 15; (10) attachment adaptor screws generally designated by the reference number 16; (11) a die 3; and (12) negative 21 and positive 22 electric feeds to the thermostat 6 and the cartridge heater 5.

As shown by FIG. 2 the adjusting lever 11 includes an adjusting lever thermostat mount slot 23 to engage the thermostat mount 12. The adjusting lever 11 is held and positioned in a holding and positioning channel 20 designed for that purpose. The adjustment lever 11 includes an adjusting lever fulcrum point 24 engaged with the wall of the opening in the insulating cup 7. The pivot point of the adjusting lever 11 is used to raise and lower the heating block 4, with a die 3 attached. The vertical travel of the heating block up and down within a circular chamber 27 machined for that purpose in the insulating cup 7. The travel of the heating block 4 is limited to ⅜″ by the adjusting lever limit slot 19 designed for that purpose.

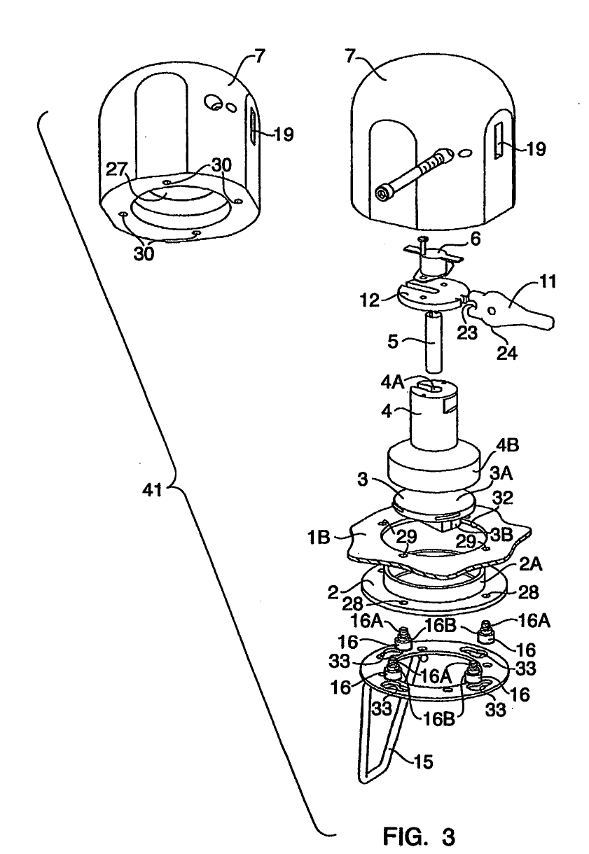

FIG. 3 illustrates in detail the installation and alignment of the heating assembly 41 components including the insulating cup 7, a heating block 4, a thermostat 6, negative 21 and positive 22 wire leads, a thermostat mount 12, a cartridge heater 5 and a seal 2.

As shown in FIG. 3, the seal 2 retains (i.e., holds) and centers the heating block 4 in the circular machined chamber 27 of the insulating cup 7. Additionally the seal 2 is designed to inhibit any air and steam vapors, as well as any accidental splashing of foam 8A or liquid 8B as the die 3 is inserted in the foam 8A, from entering the heating block 4 or circular chamber 27 machined in insulating cup 7 and fouling the heating block 4.

As shown in FIG. 3 the four adaptor screws 16 include a male threaded shank 16A and the alignment device 15 attachment lugs 16B.

The male threaded shank 16A of the adaptor screws 16 are passed through the attachment holes 28 in seal 2 which is holding and centering the heating assembly 41, then passing the male threaded adaptor screws shanks 16A through the four attachment holes 29 in the top area 1B of the apparatus body 1, provided for attaching the heating assembly 41 to the top area 1B of the apparatus body 1. The four male adaptor screw shanks 16A are inserted and screwed into the four female threaded attachment holes 30 in insulating cup 7, provided for that purpose.

As shown in FIG. 3, and as described above, the attachment of the heating assembly 41 through the seal 2 attachment holes 28 and then through the top area of the body 1B attachment holes 29 by screwing the threaded male adaptor screw shanks 16A into the female threaded hole 30 in the insulating cup 7, squeezes the heating assembly 41 together as a unit, thereby firmly attaching the heating assembly 41 to the top area 1B of body 1.

As shown in FIG. 3 the seal 2, heating block 4 and the insulating cup 7 are firmly attached to the top area of the body 1B. The attachment to the top area of the body 1B is provided by a round hole 32 with a diameter drilled to a tolerance sufficient to allow the included flange 2A of seal 2, positioning and centering the heating block 4, to pass the heating block 4 through the hole 32 in the top area 1B, designed for that purpose, it in position to align the four attachment holes 28 drilled through the seal 2 around the periphery of the hole 32 provided in the top area of the body 1B.

As shown in FIG. 3 the alignment of the heating assembly 41 clearance holes including holes 28, holes 29 and holes 32 permit the insertion of the adaptor screw threaded male shanks to be screwed into the female holes 30 in insulating cup 7, provided for this purpose; thereby squeezing seal 2, holding and centering the heating block 4, into the heating block 4 travel chamber provided in the insulating cup seal 2.

As shown by FIG. 2 and clarified by FIG. 3 the alignment device 15 is attached to the alignment device mounting lugs 16B by-passing the adaptor screw mounting lugs 16B through the elongated attachment holes 33 included in the alignment device 15, designed for that purpose, and turning the alignment device 15 one quarter turn clockwise to attach the alignment device 15 firmly to the mounting lugs 16B on the four adaptor screws 16.

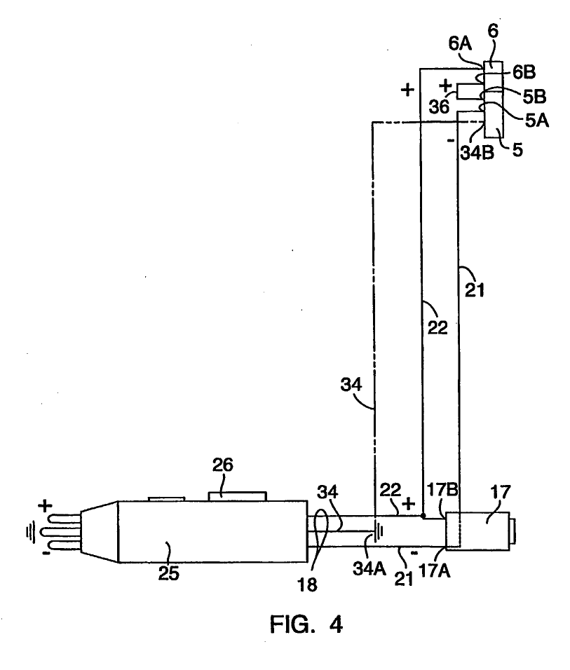

FIG. 4 electrical wiring schematic diagram details the negative 21, positive 22 and ground wire 34 electrical wiring runs and connections provided by the ground fault plug 25 and rheostat 26 and their electric supply cord 18, for the purpose of clarification.

As shown by FIG. 4 the ground 34 from the electric cord 18 is grounded to the backside of body 1 at a connecting point 34A. Additionally, the thermostat 6 and cartridge heater 5 are grounded from a connecting point 34B to the back side of body 1 at a connecting point 34A, thereby completing the electrical ground necessary to prevent accidental electrical shock provided by the ground fault plug 25.

As shown in FIG. 4 electricity is fed from the electric cord 18 through the negative 21 wire and positive 22 wire attached to the “on/off” switch 17 connecting at point 17A and 17B on the switch 17, respectively. When the switch 17 is placed in the ‘on’ position the electricity is fed from the switch 17 via the negative wire 21 to the cartridge heater 5 connecting at point 5A. A positive wire 22 feed travels from the switch 17 connection point 17B to the thermostat 6 connecting at point 6A. A positive ‘jump’ wire 36 provides the electrical feed from the thermostat 6 connection point 6B to the cartridge heater 5 connecting at point 5B; thereby completing the supply and return electrical circuitry necessary to operate the apparatus 40.

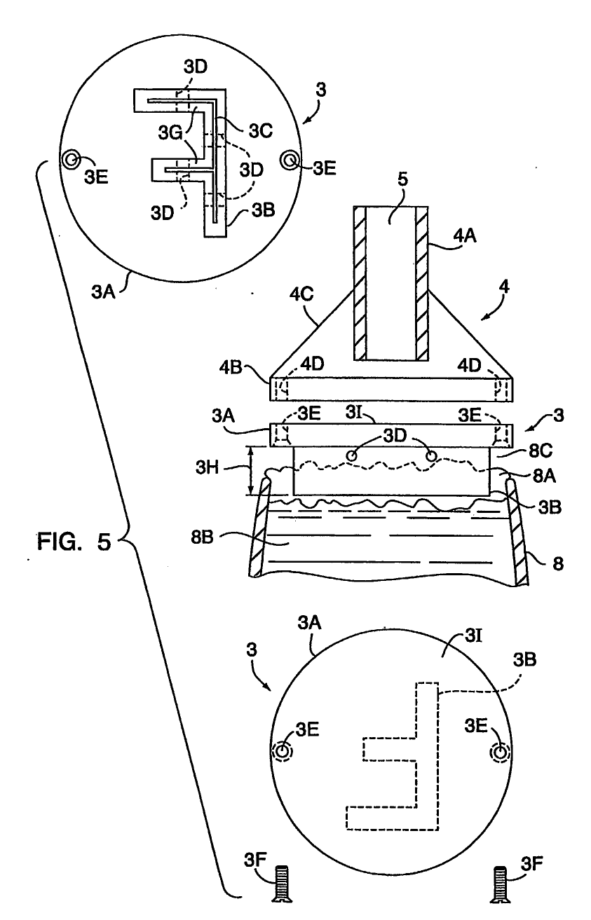

Referring to FIG. 5, the die 3 for use in the branding of foam 8A uses the controlled insertion of a die face 3B, heated to a temperature in excess of 212°, to suddenly inserted into the foam 8A sitting on top of a liquid 8B held in a container 8 for the purpose of breaking the surface tension of the molecules of air bubbles and their liquid sheaths surrounding them that form the foam; without the die face 3B having touched the liquid 8B the foam 8A is sitting on. The die 3 includes a die face 3B designed in the configuration, shape and size, as the image outline of a specified object.

The extended die face 3B is applied to the foam 8A in conjunction with a die adjusting lever 11, depicted in FIG. 2 and FIG. 4, used to control the depth of die insertion into the foam, so as to prevent the die face 3B from touching and boiling the liquid the foam 8A is sitting on as it is being held in a container 8; also to prevent the bottom surface of the heat transfer base 3A from touching and boiling the top surface of the foam 8A.

The invention presents a unique die 3 as the source of the directed/inserted heat used by the presented apparatus to apply the presented process. The die 3 is designed and machined in the precise configuration, shape and size as the image desired to be created. This is accomplished by removing material from the die heat transfer base 3A in a pattern designed to create the desired die face 3B image.

As shown by FIG. 5 the foam branding die 3 is one solid piece of material; the invention presents the die 3 as being made-up of several functional areas: (1) a heat transfer base 3A; (2) a controlled depth (or height) of the die face 3H; (3) a die face 3B; (4) a grooved channel 3C; (5) two parallel ridges 3G; (6) horizontal air/steam vapor release vents 3D; (7) attachment holes 3E; and (8) attachment screws 3F. Together these eight areas constitute the die 3.

Still referring to FIG. 5, the contact area of the heat transfer base 3A is a flat smooth surface 3I made to the same diameter as the mating surface of the heating block 4 heat transfer base 4B; The heat transfer base 4B is designed to absorb the heat from the cartridge heater 5, depicted in FIG. 2 and FIG. 4, housed in the cartridge heater chamber 4A as the heat radiates from the conical shaped heating block body 4C to the heating block heat transfer base 4B. The heat absorbed in the heat block transfer base 4B is transferred to the attached die 3 heat transfer base 3A and distributed evenly to all areas of the pattern of a specified image machined into the die face 3B.

The die heat transfer base 3B is attached to the heat block 4 by screwing the male screws 3F into the female threaded holes 4D of the heating block 4; thereby securing the die heat transfer base 3B snugly and firmly mated to the surface of the heating block base 4B. The use of screws 3F to remove and/or replace the die 3 is provided to allow a user with little, or no training to quickly and easily remove the die 3 for cleaning and to provide a quick and easy means to change dies with different die faces.

The illustrated die face 3B has an extended depth 3H of approximately ⅜″. In other embodiments the extended depth of the face of the die may be more or less than ⅜″ depending on the application. The extended die face 3B is applied to the foam 8A in conjunction with a die adjusting lever 11, depicted in FIG. 2 and FIG. 4, used to control the depth of die insertion into the foam, so as to prevent the die face 3B from touching and boiling the liquid the foam 8A is sitting on as it is being held in a container 8; also to prevent the bottom surface of the heat transfer base 3A from touching and boiling the top surface of the foam 8A. The die face 3B is machined to a depth of approximately ⅜″ by removing the material from the die 3 in the desired pattern to create the desired image; thereby leaving a die 3 heat transfer base 3A.

As shown in FIG. 5 the die face 3B is designed and machined in a two step process; first as a single ridge that forms the specified image as the die face 3B, depicted as the outline of the letter “F” in FIG. 5; secondly by machine a channel 3C or groove into the single ridge image of the die face 3B, to the ⅜″ depth of the extended depth 3H of the die face 3B thereby creating a double ridge die face 3G and a (approximately) ⅜″ deep channel 3C that acts as a reservoir designed to capture the air and stem vapors suddenly released as the die face is inserted into the foam 8A.

The double ridge die face 3G provides a tool to create the images of objects, letters and logos, etc. to be formed in the foam 8A while allowing any entrapped air and steam vapor to be released. Thus, the suddenly released air escapes to the atmosphere above the surface of the foam 8A and does not disturb the foam remaining in the glass adjacent to the image formed therein. For example, the letters I, L, T may not require a double ridge 3G channel 3C design; whereas the image outline of the letters A, B, O, and P include shapes that enclose and restrict the release of the air and steam vapors.

As shown in FIG. 5 the reservoir created by the machined channel 3C in the die face 3B has several air vent holes 3D, as may be required depending on the size and shape of the die face. The air vent holes 3D are drilled horizontally through the material that forms the sides of the double ridges 3G that form the die face 3B image. The vent holes 3D are machined into the extended depth 3H of the die face 3B. The vent holes 3D are drilled at the very base of the channel 3C to the maximum depth possible without penetrating the heat transfer base 3A.

The purpose of the vent holes 3D is to release the air and steam vapor suddenly escaping from the broken air bubbles to the atmosphere in the space 8C above the surface of the foam, provided for that purpose without disturbing the adjacent unbroken air bubbles that form the outline of the image created in the foam 8A.

As shown in FIG. 5 the controlled depth 3H of die face 3B insertion into foam 8A provides a necessary space 8C between the surface 3I of the heat transfer base 3A and the surface of the foam 8A. This space 8C is created when the ⅜″ extended die face 3B controlled depth of insertion into the foam 8A is limited to between approximately ⅛″ and ¼″; thereby leaving a designed space 8C of approximately ⅛″ and ¼″ existing between the surface of the heat transfer base 3B and the surface of the foam 8A. The space 8C is necessary because the space 8C permits the suddenly released air and steam vapor to vent to the atmosphere; without disturbing the adjacent (unbroken) air bubbles that form the outline of the image created in the foam 8A.

As illustrated in FIG. 5 the die 3 is used in conjunction with the apparatus described above to perform the process set forth in detail below to quickly, sanitarily, safely and consistently (i.e., repeatability one after the other with little or no user training; additionally the foam branding is accomplished without additives and without altering the flavor of the foam 8A or the liquid 8B that the foam is sitting on as it is held in a container.

### Process Details

It has been scientifically reported that the surface tension of water is significantly decreased as temperature is increased.

The invention presents the process as a defined method for creating an impression/branding of an outline of a specified object, logo, letter, etc., designed in a precise configuration, shape and size as the object desired to be created in the dense foam head, sitting on top of a liquid as it is held in a container, e.g. a glass or cup.

The process presented employs a controlled source of directed heat designed in a specified configuration, shape, size, to be suddenly inserted into the dense foam head sitting on top of a liquid as it is held in a container, without the directed/inserted heat source touching and boiling the liquid the foam is sitting on, for the purpose of breaking the cohesive forces of surface tension attracting the molecules of air bubbles and their liquid sheath that form the foam.

Not touching and boiling the liquid, the foam is sitting on as it is held in its container, is critical; because when the liquid is boiled the outline of the image being created in the foam is severely distorted and blurred, thereby rendering the image unrecognizable.

The temperature of the directed/inserted heat source is pre-determined and pre-set at a temperature in excess 212°, as determined by the density and thickness of the foam and the presence and type of organic matter in the foam and the type of material the die is made from. For example, an aluminum die used with the apparatus of the invention should not be heated above approximately 400°due to the relatively low melting point of aluminum. Whereas a die manufactured from steel can be heated far in excess of 400°.

The result of this sudden application of the significant directed/inserted heat, in a designed and specified image, into the dense foam head creates an impressed/branded outline in the foam in the precise configuration, shape, size as the directed/inserted heat source.

Additionally, the impressed/branded image produced may be a darker color than the foam adjacent the branded image. This is caused by the “cooking” and/or the “frying” of any organic matter present in the liquid sheath surrounding the air bubbles forming the foam in the area of the branded image.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

1. An apparatus for branding a foam portion formed on the surface of a liquid beverage disposed in a container, the apparatus comprising:
a body;
a die coupled to the body and defining an extended face having a shape corresponding to a desired brand;
a heating element coupled to the die for heating the die;
wherein the face is engageable with the foam portion of a liquid for branding foam in the shape of the face of the die.

2. The apparatus of claim 1 further comprising an alignment member coupled to the body for aligning the container relative to the face of the die during a branding process.

3. The apparatus of claim 1 wherein the heating element is electric.

4. The apparatus of claim 3 further comprising a thermostat for regulating the temperature of the die.

5. The apparatus of claim 1 further comprising means for varying the temperature of the die.

6. The apparatus of claim 1 further comprising adjustment means movably coupling the die to the body for adjusting the exposure of the extended face of the die relative to the body.

7. The apparatus of claim 1 wherein the heating element is heated to a range of about 212 degrees Fahrenheit to about 450 degrees Fahrenheit.

8. The apparatus of claim 5 wherein the means for varying the temperature of the die includes a rheostat.

9. The apparatus of claim 1 wherein the body is configured to be received in the hand of a user, the apparatus being configured as a hand-held device.

10. The apparatus of claim 1 wherein the body further comprises a bottom surface for supporting the apparatus on a support surface, the apparatus being configured as a stand-alone device.

11. A die for use with an apparatus for branding a foam portion formed on the surface of a liquid beverage disposed in a container, the die comprising:
a heat block;
an extended face coupled to the transfer portion, the face defining a shape corresponding to the shape of a desired brand; and wherein
the apparatus includes a heating element coupled to the heat block for heating the heat block and thereby the face, the face being engageable with the foam portion of a liquid for branding the foam in the shape of the face of the die.

12. A process for branding a foam portion formed on the surface of a liquid beverage disposed in a container, the process comprising the steps of:
providing a heat source defining an area corresponding to the shape of a desired brand to be formed in the foam;
heating the heat source;
engaging the heat source with the foam thereby vaporizing the foam in the area of the brand; and
allowing the vaporized foam to escape to the atmosphere.

13. The process as described in claim 13 wherein the step of heating includes heating the heat source to a temperature of at least 212 degrees Fahrenheit.
